(19) United States
(12) Patent Application Publication
(10) Pub. No.: US 2015/0250090 A1
(43) Pub. Date: Sep. 10, 2015

(54) Soil Treatment Facility

(71) Applicant: Soon Hoe Ng, Singapore (SG)

(72) Inventor: Soon Hoe Ng, Singapore (SG)

(73) Assignee: SKY URBAN IP PTE LTD, Singapore (SG)

(21) Appl. No.: 14/348,562

(22) PCT Filed: Aug. 31, 2012
(86) PCT No.: PCT/SG2012/000311

§ 371 Date: Mar. 28, 2014

(30) Foreign Application Priority Data
Sep. 30, 2011 (SG) 201107159-4

(51) Int. Cl. A01B 77/00; A01B 79/00

(52) U.S. Cl. CPC A01B 77/00; A01B 79/00

(57) ABSTRACT

A system for treatment of soil comprising: a vertical tower structure (1); at least one soil rest drum (3); and a drive unit; wherein the soil rest drum (3) configured for mounting to the vertical tower structure (1) in a manner such that the soil rest drum (3) is vertically moveable along the vertical tower structure (1) under a gravitational force; and wherein the drive unit is configured for regulating a speed of the soil rest drum (3) moving under the gravitational force.

### FIELD OF INVENTION

The present invention relates broadly to a soil treatment system and method.

### BACKGROUND

Farms, nurseries, and plantations in continuous operation quite frequently recycle and/or treat their soil before growing a new batch of products. This practice, being one prominent feature of ecological and sustainable agriculture in modern days has many advantages. Amongst the various advantages, one of which is to promote better product yield. This is achieved by reducing or eliminating the presence of weeds, insects and harmful organisms in the untreated soil through soil recycling and/or treatment process. However, this process is both strenuous and time consuming in that it typically takes weeks to months for one batch of soil to be recycled and/or treated. Also, existing recycling and/or treatment systems generally require large designated sites due to the large quantity of soil to be recycled and/or treated after each cycle of cultivation. The drawbacks associated with existing recycling and/or treatment systems run foul of the benefits brought by soil recycling and/or treatment, depriving those with time and/or space constraints from adopting the good practice. Therefore, it is highly desirable to have a more efficient system for soil recycling and/or treatment. In view of the foregoing, the prevent invention is thought to advantageous provide among other things, a more efficient soil recycling and/or treatment system,

### SUMMARY

According to a first aspect of the invention, there is provide a system for treatment of soil comprising: a vertical tower structure; at least one soil rest drum; and a drive unit; wherein the soil rest drum configured for mounting to the vertical tower structure in a manner such that the soil rest drum is vertically moveable along the vertical tower structure under a gravitational force; and wherein the drive unit is configured for regulating a speed of the soil rest drum moving under the gravitational force.

The drum may comprise soil turning unit configured for turning of a soil contained in the soil drum.

The soil turning unit may comprise a rotatable shaft and a blade connected to the shaft.

The rotatable shaft may be configured to rotate under the gravitational force.

The rotatable shaft may be coupled via one or more gears to a gear track on the vertical tower structure

The system may further comprise locking unit for locking the drum at a predetermined height along the vertical tower structure.

According to a second aspect of the invention, there is provided a method for treatment of soil, the method comprising the steps of: providing a vertical tower structure; providing at least one soil rest drum; providing a drive unit; and mounting the soil rest drum to the vertical tower structure in a manner such that the soil rest drum is vertically moveable along the vertical tower structure under a gravitational force; and regulating a speed of the soil rest drum moving under the gravitational force using the drive unit.

### BRIEF DESCRIPTION OF THE DRAWINGS

Embodiments of the invention will be better understood and readily apparent to one of ordinary skill in the art from the following written description; by way of example only, and in conjunction with the drawings, in which:

FIG. 1(a) is a diagrammatic representation of an embodiment showing the side plan view of a vertical tower structure with a drum loaded.

FIG. 2 is the front plan view of the vertical tower structure in FIG. 1(a).

FIG. 4(a) shows the front view of an embodiment of the soil rest drum that can be loaded onto the vertical tower structure in FIG. 1(c).

FIG. 4(b) shows the side view of the soil rest drum in FIG. 4(a).

FIG. 4(c) shows the top view of the soil rest drum in FIG. 4(a).

FIG. 5 is a diagrammatic representation of an examplary gear system which can be used with the soil rest drum in FIG. 4(a) and with the vertical tower system in FIG. 1(c).

FIG. 6 shows a flow chart illustrating a method for treatment of soil according to an example embodiment.

### DETAILED DESCRIPTION

Embodiments of the invention relate to soil treatment and recycling facility which promotes plant vigor, increases yield and improves quality of crops growing on the treated soil by reducing or eliminating the presence of weeds, insects and harmful organisms in the soil. The process can also advantageously help to reduce the use of pesticides during later stage of plant growth cycle.

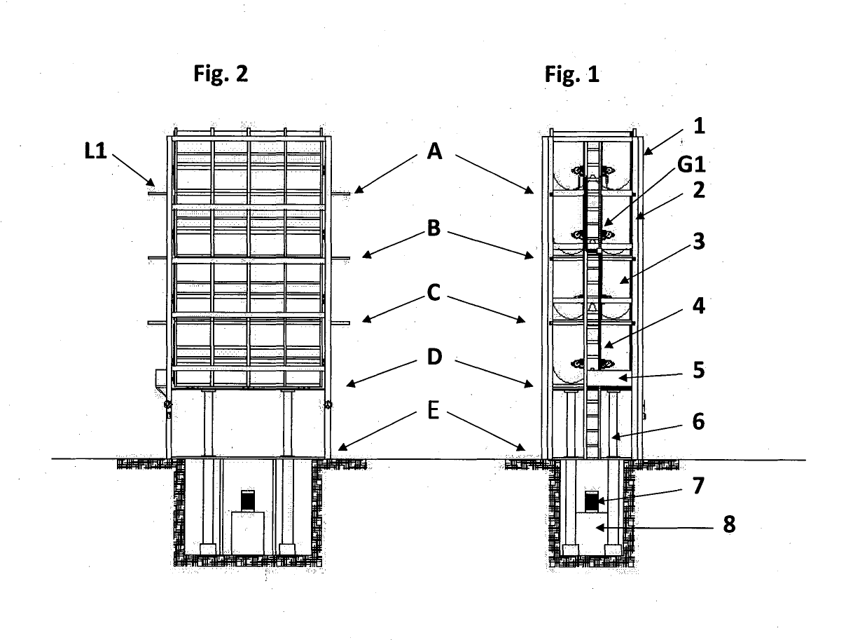

FIGS. 1 and 2 provide diagrammatic representations of an embodiment of the invention, wherein a vertical tower structure 1 holds four soil drums 3 when fully loaded. The said vertical tower structure 1 is operable to house one or more soil rest drums 3 each mounted in a drum holder frame 2 that will move along a gear track 4 during the soil treatment and/or recycling process. As shown in FIG. 1 (a), the gear track 4 extends along the vertical central axis of the vertical tower structure 1. However, it will be appreciated that the gear track 4 can also be positioned at other places along the vertical tower structure 1. Further, it is also understood that the tower structure 1 may be designed to hold any number of soil rest drums 3 stacked on top of one another as desired.

According to the above embodiment, soil subjected to treatment and/or recycling is contained in each soil rest drum 3.

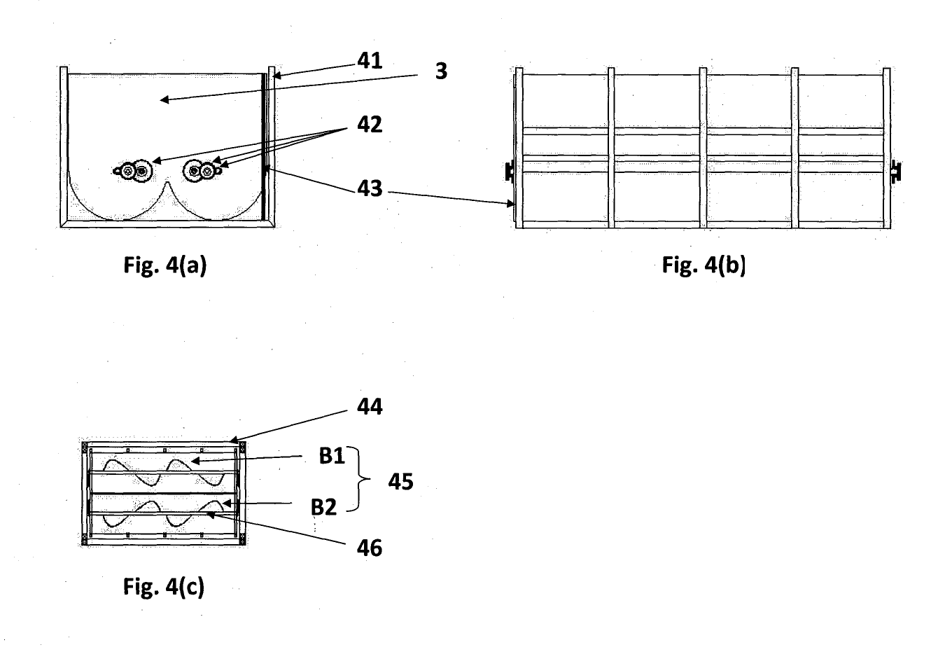

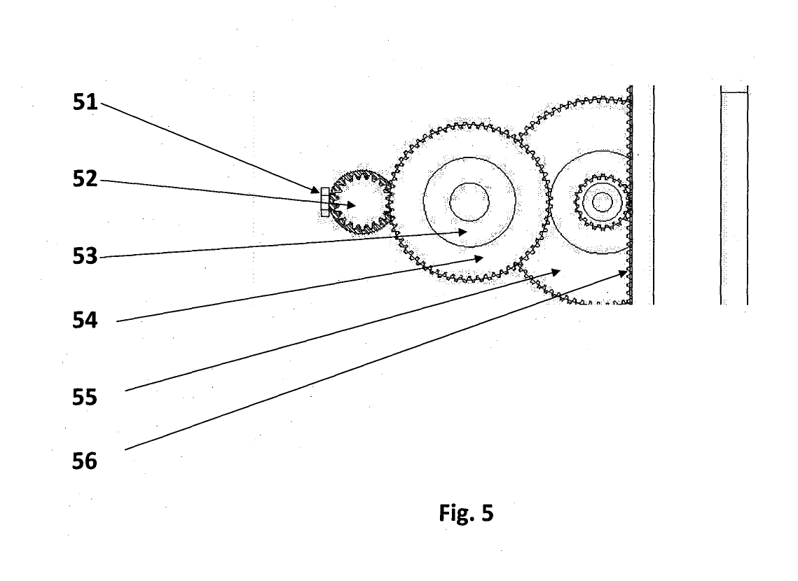

According to the above embodiment, two sets of steel blades B1 and B2 are installed inside the soil rest drum 3. An exemplary way of implementing the blades is shown in FIG. 4 (c). The blades B1 and B2 are operable to turn the soil contained inside the soil rest drum 3. Gear track 4 (FIG. 1) fixed at the centre of the tower structure 1 is used to drive the blades B1 and B2 so that they rotate to provide turning and aeration to the soil contained inside the soil rest drum 3, thereby aiding rapid odor-free decomposition. As the soil rest drum 3 moves downward under gravitational force, the gear track 4 allows a set of gears G1 attached to the soil rest drum 3 to be driven which in turn drive the blades B1 and B2 inside the soil rest drum 3. It will be appreciated that any number of blades or variations thereof can be used to provide turning and aeration to the soil. Further, the blades may be made of non-steel materials and be installed at various positions relative to the soil rest drum 3 insofar as turning can be provided.

According to the above embodiment, soil contained in one soil rest drum 3 in the system takes approximately 96 hours to complete the treatment and/or recycling process by moving from position A to E. It takes approximately 24 hours for a soil rest drum 3 to move from an initial position to the next. For instance, a soil rest drum 3 drum will take roughly 24 hours to move from position A to position B, roughly 48 hours to move from position A to position C, and so on.

At the beginning of the process, a soil rest drum 3 is loaded to position A using an industrial hoist or otherwise. The soil rest drum 3 is then allowed to reach position B by descending along the gear track 4 under gravitational force. The travel time from A to B is approximately 24 hours. This is controlled by using a hydraulic system comprising at least one drive unit in the form of a hydraulic cylinder 6, a pump 7 and a hydraulic power rack 8 working with a feedback system (not shown) to regulate the speed at which the soil rest drum 3 moves along the tower structure 1. The feedback system prompts the hydraulic system to react according to the gross weight of the soil rest drum 3 and the drum holder frame 2 to which the former is mounted on such that the soil rest drum 3 will always take approximately 96 hours to move from position A to E regardless of the amount of soil it contains. Desired speed of descending is achieved by controlling the flow rate of the hydraulic fluid back into the reservoir via an electrically controlled valve opening (not shown) or otherwise.

It will be appreciated that various other ways of loading the soil rest drum 3 to position A can be used with this system. Also, other means of regulating and/or controlling the speed of the soil rest drum 3 can also be used in conjunction of the system.

Generally, when a soil rest drum 3 has traveled from position A to position E, that is approximately 96 hours after the starting time, the process of treatment and/or recycling is considered to be completed. When the soil rest drum 3 reaches position E, a system lock-in is triggered. An exemplary way of carrying out the lock-in is by instituting a holding mechanism. An exemplary of such mechanism is shown in FIG. 2 where a bar L1 made of suitable material is mounted on both ends of the vertical tower structure 1 (FIG. 1) at positions A, B and C. L1 can be remotely controlled using for example a switch box. As a pair of L1s is pushed inward, each L1 slots into a receiving unit (not shown) on the drum holder frame 2 (FIG. 1) so that the soil rest drum 3 contained in that drum holder frame 2 will be locked in position. The bars L1 may be made using G/Steel square solid bars or any other suitable materials. Further, it will be appreciated that other automated of manual methods and/or mechanisms can be used in different embodiments.

During the lock-in, the lowest soil rest drum 3 at position E is removed from the tower structure 1 (FIG. 1). Another soil rest drum 3 filled with untreated soil may be placed at the top of the tower structure 1, where the starting position A is, for treatment and/or recycling. The newly loaded soil rest drum 3 will be locked at that position and remain still until the whole system is discharged from lock-in. With the soil rest drum 3 at position E removed, the hydraulic cylinder 6 is then raised to support the soil rest drum 3 at position D. In the present embodiment, the hydraulic pump 7 in the hydraulic system pushes a fluid which in turn extends the hydraulic cylinder 6 and makes the hydraulic piston moves upwards to position D. The hydraulic pump 7 is stopped once the piston of hydraulic cylinder 6 is fully extended (to reach position D). Thereafter, all remaining soil rest drums on the tower structure 1 are released from lock-in; they descend along the tower structure 1 and the treatment and/or recycling process continues. The hydraulic cylinder 6 used in the present embodiment can reach any point between D and E. Nevertheless, it is understood that hydraulic cylinders of higher reaching ranges can also be used in alternative embodiments.

The lock-in is also useful during the initial stage of the continuous recycling operation in that when the vertical tower structure 1 (FIG. 1) of the present embodiment is first erected and made ready for use, an empty soil rest drum 3 is loaded to position D from the top from the empty tower structure 1 using an industrial hoist or otherwise. The empty soil rest drum 3 is locked at position D by the lock-in mechanism so that a second empty soil rest drum 3 can be similarly loaded to position C and locked at that position. Thereafter, a third empty soil rest drum 3 is loaded to and locked at position B in the same way allowing a fourth soil rest drum 3 containing the first batch of soil for recycling and/or treatment to be loaded to position A and locked at the top of the tower structure 1. When the tower structure 1 is fully loaded with 4 soil rest drums 3 stacked on top of each other and in their respective lock-in positions, the hydraulic cylinder 6 is raised to position D to support the lowest soil rest drum 3. Then all the drums are released from lock-in and they start to move down the tower structure 1 under gravitational force. When the lowest soil rest drum 3 reaches position E, lock-in is again triggered so that the empty soil drum 3 can be removed from position E allowing another filled soil rest drum 3 to be placed at position A of the tower structure 1. In this way, the process continues allowing more and more filled soil rest drum 3 to be introduced into the system.

It will be appreciated that in place of empty soil rest drum 3, dummy drums and/or other means can also be used to initiate the recycling process described herewith. For example, a hydraulic cylinder 6 of higher reaching range may be used. In this alternative configuration, filled soil rest drum 3 is loaded to and locked at position A, and the hydraulic cylinder is raised to position A to support the soil rest drum 3. The soil rest drum 3 is then released from lock-in and allowed to descend along the tower structure 1 until it reaches position B, where another filled soil rest drum 3 can then be placed at position A again with or without instituting a lock-in. When the first filled soil rest drum 3 reaches position C, the second filled soil rest drum would have reached position B. Again, a further filled soil rest drum 3 can be loaded to position A and the process continues till the tower structure 1 is fully loaded; in this case with four filled soil rest drums 3. Examplary embodiment of the soil rest drum 3 is provided in FIG. 4(a) through 4(c) wherein, the soil rest drum 3 is housed in drum holder frame 41, with sets of ground spur gears 42 installed on its front face. The drum holder frame 41 further comprises a gear track 43 aligned to its vertical edge. When the drum holder frame 41 moves down with the soil rest drum 3 mounted on it and passes through the generator 5 (shown in FIG. 1), the gear track 43 drives the generator 5. In this process, mechanic energy is converted to electrical energy with the latter harnessed and used to power the soil treatment system, at least partially. The electrical energy produced by the aforesaid energy conserving feature can for example be used to power the hydraulic pump 7 (FIG. 1), and/or lock-in, etc. However, it is understood that additional power from external source (not shown) may be provided to operate the soil treatment system. The soil rest drum 3 further comprises sets of blade 45 mounted on a shaft 46 connected to the ground spur gears 42 so that the shaft 46 and hence the blades 45 are turned by the action of the ground spur gears 42. Metallic material such as steel may be used to fabricate the drum holder frame 41 and M/Steel can be used to make the blades 45 and/or shaft 46.

In one embodiment, the soil drum 3 has dimensions of about 3100×1900×1125 (measured in mm) to contain approximately 6 tones of soil each. However, it will be appreciated that drums of other dimensions may also be used.

FIG. 5 shows an examplary planetary gear system which can be used in the embodiment discussed above. The said gear system consists of a lock screw 51 fitted next to a first ground spur gear 52 that is attached to a soil rest drum shaft 53 and is engaged to the teeth of a second and larger ground spur gear 54. The second spur gear 54 is engaged to the teeth of a third and even larger ground spur gear 55 on the opposite side of ground spur gear 53. Ground spur gear 55 is engaged to the teeth of the gear track 56 on the opposite side of ground spur gear 54. The lock screw 51 is provided to prevent unwanted movements of the gears when the soil rest drum 3 is not moving.

According to the above embodiment, it is estimated that approximately 23 tones of soil can be treated and/or recycled in a 3-4 day program to eliminate harmful microorganisms and pests that may be present in the untreated soil. The use of vertical tower further advantageously conserves space comparing to other methods which usually require occupancy of large area of land.

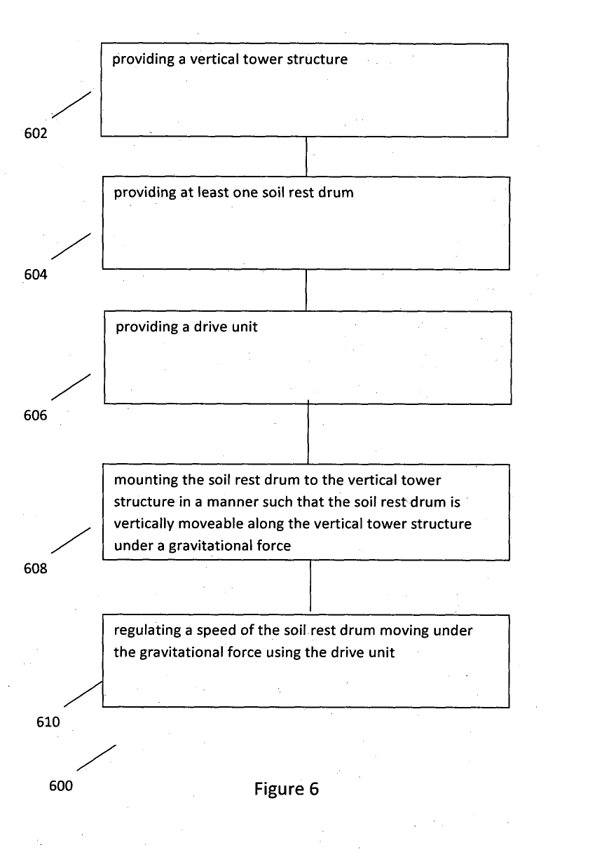

FIG. 6 shows a flow chart 600 illustrating a method for treatment of soil according to an example embodiment. At step 602, a vertical tower structure is provided. At step 604, at least one soil rest drum is provided. At step 606, a drive unit is provided. At step 608, the soil rest drum is mounted to the vertical tower structure in a manner such that the soil rest drum is vertically moveable along the vertical tower structure under a gravitational force. At step 610, a speed of the soil rest drum moving under the gravitational force is regulated using the drive unit.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, while a hydraulics system has been described in the example embodiment, it will be appreciated that other drive mechanisms may be used in different embodiments.

1. A system for treatment of soil comprising:
a vertical tower structure;
at least one soil rest drum; and
a drive unit;
wherein the soil rest drum configured for mounting to the vertical tower structure in a manner such that the soil rest drum is vertically moveable along the vertical tower structure under a gravitational force; and
wherein the drive unit is configured for regulating a speed of the soil rest drum moving under the gravitational force.

2. The system as claimed in claim 1, wherein the drum comprises a soil turning unit configured for turning of a soil contained in the soil drum.

3. The system as claimed in claim 1, wherein the soil turning until comprises a rotatable shaft and a blade connected to the shaft.

4. The system as claimed in claim 3, wherein the rotatable shaft is configured to rotate under the gravitational force.

5. The system as claimed in claim 4, wherein the rotatable shaft is coupled via one or more gears to a gear track on the vertical tower structure

6. The system as claimed in claim 1, further comprising a locking unit for locking the drum at a predetermined height along the vertical tower structure.

7. A method for treatment of soil, the method comprising the steps of:
providing a vertical tower structure;
providing at least one soil rest drum;
providing a drive unit; and
mounting the soil rest drum to the vertical tower structure in a manner such that the soil rest drum is vertically moveable along the vertical tower structure under a gravitational force; and
regulating a speed of the soil rest drum moving under the gravitational force using the drive unit.

8. The system as claimed in claim 2, wherein the soil turning until comprises a rotatable shaft and a blade connected to the shaft.

9. The system as claimed in claim 8, wherein the rotatable shaft is configured to rotate under the gravitational force.

10. The system as claimed in claim 9, wherein the rotatable shaft is coupled via one or more gears to a gear track on the vertical tower structure.

11. The system as claimed in claim 2, further comprising a locking unit for locking the drum at a predetermined height along the vertical tower structure.

12. The system as claimed in claim 3, further comprising a locking unit for locking the drum at a predetermined height along the vertical tower structure.

13. The system as claimed in claim 4, further comprising a locking unit for locking the drum at a predetermined height along the vertical tower structure.

14. The system as claimed in claim 5, further comprising a locking unit for locking the drum at a predetermined height along the vertical tower structure.

15. The system as claimed in claim 6, further comprising a locking unit for locking the drum at a predetermined height along the vertical tower structure.

16. The system as claimed in claim 8, further comprising a locking unit for locking the drum at a predetermined height along the vertical tower structure.

17. The system as claimed in claim 9, further comprising a locking unit or locking the drum at a predetermined height along the vertical tower structure.

18. The system as claimed in claim 10, further comprising g a locking unit for locking the drum at a predetermined height along the vertical tower structure.
